(19) United States
(12) Patent Application Publication
(10) Pub. No.: US 2024/0326037 A1
(43) Pub. Date: Oct. 3, 2024

(54) Apparatus for Measuring and Dispensing Particulates

(71) Applicant: Northeastern University, Boston, MA (US)

(72) Inventors: Meni Wanunu, Sharon, MA (US); Ali Fallahi, Boston, MA (US); Amr Khalid Makhamreh, Boston, MA (US)

(21) Appl. No.: 18/582,489

(22) Filed: Feb. 20, 2024

Related U.S. Application Data
(60) Provisional application No. 63/485,825, filed on Feb. 17, 2023.

(51) Int. Cl. B01L 3/00; G01N 15/10

(52) U.S. Cl. CPC B01L 3/502; G01N 15/1023; B01L 2200/0647; B01L 2300/0645; B01L 2300/0681; B01L 2300/16; B01L 2400/0415; B01L 2400/0418; G01N 2015/1028

(57) ABSTRACT

Systems and methods for controlled delivery of a specified quantity of particles. Systems involve a flow cell containing primary and secondary fluid chambers separated by a membrane, and a flow-producing module to induce particle translocation. Methods involve translocating particles between chambers through membrane activation, potentially for sorting and dispensing into target containers.

### RELATED APPLICATION(S)

This application claims the benefit of U.S. Provisional Application No. 63/485,825, filed on Feb. 17, 2023. The entire teachings of the above application(s) are incorporated herein by reference.

### GOVERNMENT SUPPORT

This invention was made with government support under Grant No. 2141135 awarded by the National Science Foundation. The government has certain rights in the invention.

### BACKGROUND

Viral vectors and nanoparticles are widely used as delivery agents for various drug and gene cargoes, and in modern vaccines and therapeutics gene delivery is an area of prime importance in global health. Furthermore, an important step in achieving specificity for targeting particles to tissues is the decoration of particles and viruses with receptor-binding molecules or high-affinity proteins. However, due to the complex bio-manufacturing process of viral vectors, the product normally consists of a mixture of both functional, and damaged, empty, or aggregated particles, all of which elicit an immunogenic response (e.g., neutralizing antibodies, excessive inflammation, or adverse autoimmune responses), and may compete for available target receptors. Optimization of the product composition and effective dosing requires a method for quantifying both the composition and the functional titer present in a total particle mixture.

### SUMMARY

An example embodiment of the invention is a platform that facilitates controlled delivery of a specified quantity of particles from a primary to secondary chamber. An example embodiment of a device that may be employed by the platform combines single-channel sensors, e.g., nanopores, with multi-channel meshes to achieve a wide dynamic range when it comes to the number of particles that can be collected. A method enabled by the example device is a method that uses nanopores for dispensing a predetermined number of particles into a collection chamber.

One embodiment of the invention is a system for dispensing translocated particles, the system comprising: a flow cell defining multiple primary fluid chambers and at least one secondary fluid chamber, the multiple primary fluid chambers and the secondary fluid chamber separated at least in part by a membrane, a first portion of the membrane associated with a corresponding first primary fluid chamber and a second portion of the membrane associated with a corresponding second primary fluid chamber; and a flow-producing module in operative arrangement with the multiple primary fluid chambers and the at least one secondary fluid chamber and configured to cause a flow between the multiple primary fluid chambers and the at least one secondary fluid chamber via a respective first portion or a respective second portion of the membrane, the flow-producing module, when activated, causes particles to translocate from the multiple primary fluid chambers to the at least one secondary fluid chamber.

In another embodiment, the system may comprise a single-channel membrane and a precision mesh membrane. The flow-producing module may comprise an electrode assembly configured to cause an ionic current to flow between the first portion of the membrane and the second portion of the membrane. The system may further comprise an adjustable power source that activates the electrode assembly to produce (i) a first strength of an electric field applied by the electrode assembly between a primary fluid chamber with a respective single-channel membrane and a corresponding at least one secondary fluid chamber and (ii) a second strength of an electric field applied by the electrode assembly between a primary fluid chamber with a respective precision mesh membrane and a corresponding at least one secondary fluid chamber, a relative magnitude of the first strength and the second strength producing predictable corresponding rates of particles to pass through a channel defined by the single-channel membrane and channels defined by the precision mesh membrane. The multiple primary fluid chambers may include a first primary fluid chamber with the single-channel membrane, defining a single channel through which particles exit the first primary fluid chamber a single particle at a time to the at least one secondary fluid chamber, and a second primary fluid chamber with the precision mesh membrane, defining a precision mesh arrangement of channels through which particles exit the second primary fluid chamber multiple particles at a time to at least one of the at least one secondary fluid chamber. At least one of the multiple primary fluid chambers may define an inlet, through which particles enter the at least one of the multiple primary fluid chambers, and an outlet, through which the particles exit the at least one of the multiple primary fluid chambers.

Further, the single-channel membrane(s) may define(s) a single circular or other geometry channel with an average opening diameter of from about 10 nanometers to 10 micrometers; and the precision mesh membrane(s) may define(s) a precision mesh arrangement of similar circular or other geometry channels with average opening diameters of from about 10 nanometers to 10 micrometers. The single-channel membrane(s) may define(s) a channel configured to enable translocation of particles with average diameters ranging from at least 10% of an average diameter of the channel to 110% of the average diameter of the channel; and the precision membrane(s) may define(s) channels configured to enable translocation of particles with average diameters ranging from at least 10% of an average diameter of the channels to 110% of the average diameter of the channels. Channels defined by the precision mesh membrane may be separated by 1.1 to 100 times an average diameter of the channels, and an arrangement of the channels within a mesh may be a regular lattice.

In other related embodiments, the channel of the single-channel membrane and the multiple channels of the precision mesh membrane may have channel walls that are covered by a coating, wherein the coating is selected from a group consisting of: HfO₂, TiO₂, ZrO₂, Al₂O₃. SiO₂ or a combination thereof. The coating may be further covered by a layer of a compound with at least one phosphonate group and/or at least one silane group. The coating may be about 1 nm to about 1 um thick.

In other related embodiments, the multiple primary fluid chambers may include a primary fluid and a given one of the at least one secondary fluid chamber may define (i) a respective inlet, configured to receive a respective secondary fluid, and (ii) a respective outlet, configured to dispense the respective secondary fluid and the particles translocated from at least one of the multiple primary fluid chambers into the given one of the at least one secondary fluid chamber.

Another embodiment comprises a method for translocating particles, the method comprising enabling particles to be translocated between multiple primary fluid chambers, via a membrane having a first portion and a second portion, and at least one secondary fluid chamber; and translocating the particles from the multiple primary fluid chambers to the at least one secondary fluid chamber through activation of a flow through the membrane via the first portion or the second portion. The flow that causes translocation may be an ionic current flow, fluid volume flow, electro-osmotic flow, or a combination thereof. The method may further comprise enabling particles to be translocated between multiple primary fluid chambers, via a membrane having a first portion and a second portion, and at least one secondary fluid chamber; and translocating the particles from the multiple primary fluid chambers to the at least one secondary fluid chamber through activation of a flow through the membrane via the first portion or the second portion. The translocated particles may be dispensed from at least one of the at least one secondary fluid chamber into one or multiple target containers. The translocated particles may be dispensed to the one or multiple target containers in a sorted order according to at least one measured property of the particles. In another related embodiment, the first portion of the membrane may be a single-channel membrane that defines a single channel and the second portion of the membrane may be a precision mesh membrane that defines an arrangement of channels, and further including: sensing a rate of translocation of single particles through the single channel of the single-channel membrane as a function of an amplitude of a flow through the single channel; and determining a number of particles translocated through the arrangement of channels through the precision mesh membrane as a function of the rate of translocation of the single particles through the single channel. In another related embodiment, the method may comprise performing a calibration operation to correlate a quantity of particles translocating through the arrangement of channels of the precision mesh membrane with the rate of translocation of single particles through the single channel of the single-channel membrane for at least one amplitude of the flow through the single channel. The flow that causes translocation may be an ionic current flow, fluid volume flow, electro-osmotic flow, or a combination thereof. Further, translocating the particles may include controlling a rate the particles are translocated.

Another embodiment comprises a device for dispensing translocated particles, the device comprising: multiple primary fluid chambers; and a membrane, a first portion of the membrane associated with a corresponding first primary fluid chamber and a second portion of the membrane associated with a corresponding second primary fluid chamber, the first portion and the second portion of the membrane enabling a corresponding rate of particles to translocate therethrough. The first portion of the membrane may be a single-channel membrane that defines a single channel through which, during operation, particles exit the first primary fluid chamber a single particle at a time, and the second portion of the membrane may be a precision mesh membrane that defines a precision mesh arrangement of channels through which, during operation, particles exit the second primary fluid chamber multiple particles at a time.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A-B is a schematic diagram illustrating a multi-membrane device comprising multiple primary fluid chambers and a secondary fluid chamber, separated by two membranes with single channels and two with channel meshes.

FIG. 2A is a schematic diagram illustrating a multi-membrane device comprising multiple primary fluid chambers and a secondary fluid chamber, separated by two membranes with single channels and two with channel meshes and an electrode assembly. Translocation of particles from the primary chambers through the single channels into the secondary chamber upon the activation of corresponding electrodes. FIG. 2B: Current readouts I1 and I2 are read, recorded, and analyzed.

FIG. 3 is a schematic diagram illustrating a multi-membrane device comprising multiple primary fluid chambers and a secondary fluid chamber, separated by two membranes with single channels and two membranes with channel meshes and an electrode assembly. Translocation of particles through the channel meshes into the secondary chamber happens upon the activation of corresponding electrodes. A larger number of particles (relative to single channels) is dispensed and collected in the secondary chamber.

FIG. 4 is a schematic diagram illustrating a multi-membrane device comprising multiple primary fluid chambers and a secondary fluid chamber, separated by two membranes with single channels and two with channel meshes and an electrode assembly. Fluid is flown through the secondary chamber, and translocated particles collected in the fluid are pushed out of the flow cell.

FIG. 5 is a schematic diagram illustrating a multi-membrane device comprising multiple primary fluid chambers and two secondary fluid chamber, separated by two membranes with single channels and two with channel meshes and an electrode assembly. A primary fluid including particles enters each primary fluid chamber via a respective inlet and exits via a respective outlet. Fluid is flown through each secondary chamber, and translocated particles collected in the fluid are pushed out of the flow cell.

FIG. 6A is a schematic diagram illustrating a device comprising multiple primary fluid chambers and a secondary fluid chamber, separated by a membrane with channel meshes and an electrode assembly. A third electrode is positioned directly on channels (orange). When the third electrode is off, particles diffuse freely in any direction (FIG. 6A). When the third electrode is turned on, particles are electrically driven toward the membrane and are locally concentrated at the channels (FIG. 6B).

FIG. 7 is a schematic diagram illustrating a cross-section of a realistic design of a flow cell containing a chip, attached to fluid inflow and outflow ports, dispensing translocated particles into a target container (e.g., cell culture medium).

FIG. 8A is a schematic diagram illustrating nanopore chip, FIG. 8Bi-iii is a system for translocating particles comprising the nanochip and FIG. 8C is a cross-section of a channel on the chip.

FIG. 9A-F is a diagram illustrating FIG. 9A: current blockade signal of translocation event through a pore, FIG. 9B: event duration histogram, FIG. 9C: fractional blockade histograms, FIG. 9D: average capture rate, and FIG. 9E-F: capture rate vs particle concentration.

FIG. 10A-E outlines characterization of mesh pore membrane properties. FIG. 10A: COMSOL simulations of the XZ electric field intensity profile in SPMs at −300 mV (left) and MPMs at −1.5 V (right), shown on logarithmic scale. The bottom graphs show z-axis line profiles of the field intensity at the center of the pores. The MPMs with a 1 ∪m pitch show a reduction in e-field compared to SPMs due to the proximity of the pores. FIG. 10B: Experimental evaluation of the positive voltage value required to fully stop translocation of particles and counteract diffusion. At 1V and above, the particle counts in collected fractions fall below the limit of detection using the slide-imaging technique in this embodiment. FIG. 10C-D: Cumulative count of particles in consecutive dispensing steps at −1.5 V, swept from 1 to 5 minutes, plotted against the cumulative dispensing time. Each grey line represents an MPM. The red line shows the least-squares fit of the model in Equation 1. The dashed line is the expected cumulative dispensing count in absence of clogging (pclog=0). FIG. 10E: Correlation of the MPM particle dispensing rate per pore with SPM translocation rate interpolated at the average current-per-pore for the MPM. Each point is mean and error of SPM (x-axis) and MPM (y-axis) rates obtained from the multiple membranes of one chip for one sample concentration. (total: 6 nanopore chips). All MPM datapoints are strictly taken from under 400 s cumulative dispensing time to neglect the effects clogging. Without further corrections, we observe that current-per-pore equalization when interpolating the SPM rate brings the datapoints close to the y=x line, which makes the MPM dispensing rate predictable.

FIG. 11A-B. Binding of VLPs to cultured cells. FIG. 11A: Microscope images of MPM-translocated S-VLPs and B-VLPs (green) incubated on cells (grey: brightfield, blue: DAPI nuclear staining) show different densities of binding to cells. The specific, high-density binding of S-VLPs to the ACE2-expressing cell culture is easily distinguished from the three non-specific examples. The bottom row shows a zoomed in view with identified VLPs marked with circles, classified as on-cell or off-cell. Scale bar=50 μm. FIG. 11B: On cell binding density normalized by particle concentration at the time of incubation on cells, shown for VLP samples translocated through the MPMs (left) and VLP samples pipetted onto cells after direct dilution from the stock sample (right). Each datapoint is the analysis result of one image.

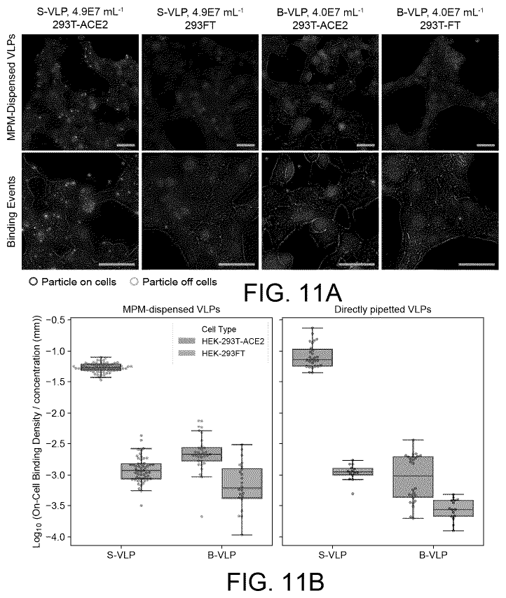

### DETAILED DESCRIPTION

A description of example embodiments follows.

Viral vectors and nanoparticles are widely used as delivery agents for various drug and gene cargoes, and in modern vaccines and therapeutics gene delivery is an area of prime importance in global health. [1, 2] Furthermore, an important step in achieving specificity for targeting particles to tissues is the decoration of particles and viruses with receptor-binding molecules or high-affinity proteins. However, due to the complex bio-manufacturing process of viral vectors, the product normally consists of a mixture of both functional, and damaged, empty, or aggregated particles [3, 4], all of which elicit an immunogenic response (e.g., neutralizing antibodies, excessive inflammation, or adverse autoimmune responses) [5], and may compete for available target receptors.

Optimization of the product composition and effective dosing requires a method for quantifying both the composition and the functional titer present in a total particle mixture. Our work aims to address the shortcomings of existing quantification methods by coupling a physical particle count with functional titer. Characterizing bio-manufactured viral particles involves measuring both physical particle count and a measure of functionality, such as viral genome count or transducing units. Currently, the most widely used physical titering approach is to measure quantities of one or a few viral protein types in a sample and calculate particle count based on protein count. The protein count can be obtained using various techniques, such as ELISA-based assays, denaturing gel electrophoresis, chromatography [4, 6], and mass-spectrometry [7].

While these techniques benefit from high specificity for the target proteins against other proteins and cell debris, they cannot discriminate between fully-formed viral particles and viral proteins in free form or viral fragments. Dynamic/static light scattering (DLS/SLS) [8, 9] and nanoparticle tracking analysis (NTA) [7-9] can directly measure the size and concentration of particles simultaneously, which reduces the effect of free or partially assembled viral proteins but are not specific to the viral particles of interest: highly scattering media, large protein aggregates, extracellular vesicles, and other debris can complicate the readout.

Flow-virometry techniques using fluorescent labels (nucleic acid staining dyes and dye-labeled antibodies) have proven successful in quantifying genome-carrying lentiviral or other large viral particles, but require highly specific antibodies for labeling the virion surface proteins. Lastly, the gold standard of particle sizing and concentration measurement, transmission electron microscopy (TEM), is labor-intensive and relies on expensive high-maintenance equipment [10].

Functional titering of virus samples takes several forms: Quantification of the genomic payload is often done via qPCR/RT-qPCR, and more recently digital droplet PCR. Transducing units are often measured using a reporter gene as the payload (such as GFP) in a cell transduction assay, followed by fluorescence quantification. Payload expression titers are performed via antibody labeling of protein of interest in the transduced cells, followed by quantification via flow cytometry. The infectivity of some replicating virions can also be quantified using the median tissue culture infectious dose (TCID50) or plaque assays [11, 12]. All functional titers result in a functional units-per-unit-volume value. Ultimately, this value coupled with physical titer results yields the quality metric of interest “specific activity” [7], which is expressed as functional units per particle.

Nanopore-based approaches for particle sizing and quantification, inspired by the Coulter Counter, are referred to as Resistive Pulse Sensing (RPS) because of the transient ionic current blockade caused by the particles during translocation [13]. RPS methods have presented a high sizing accuracy, but often require calibration with a standard particle sample for accurate concentration measurement. Furthermore, clogging has been considered a significant challenge for nanopores due to both jamming of large aggregates and particle-to-pore adsorption, rendering the pore unusable. Commercial Tunable RPS systems take advantage of a dynamically stretchable plastic membrane and propriatary coating materials to lower the effects of clogging during measurements [8, 15]. Commercial Microfluidic-RPS (MRPS) devices contain a microfluidic filter to prevent large particles from reaching and clogging the pore. [16, 17]. These devices are currently in use for characterization of viral vectors, lipid nanoparticles, and extracellular vesicles, and other biologically relevant colloids.

To our knowledge, prior nanopore-based approaches have been limited to size and concentration measurement [14, 15]. In this work, we aim to obtain functional units per particle for a nanoparticulate sample using a device that offers a combination of a nanopore analyzer for quantification and a nanopore mesh dispenser. We demonstrate that electric fields can be used as “quantitative gates” for dispensing nanoparticulates including nanoparticles, virus-like nanoparticles, and viruses. This voltage-based approach allows a preset number of particles to be rapidly dispensed into an automated collection chamber, which are then evaluated through a functional titer assay. The throughput and dynamic range that our device allows >10⁷ nanoparticles to be dispensed accurately in just a few minutes.

In one embodiment according to the present invention, the disclosure relates to an apparatus composed of one or many primary and secondary fluid chambers, where the primary and secondary chambers are separated by a freestanding membrane supported by a substrate (chip, nanopipette, etc.). The fluid in primary and secondary chambers is connected via precisely fabricated holes (channels) in the membrane with sizes ranging from 10 nm to 10 μm, using microfabrication methods (photolithography, e-beam lithography, focused ion beam milling, focused electron beam drilling, etc.) or other means. The fluid chambers contain an electrolyte (conductive) solution. An electrical potential difference applied to the primary and secondary chambers establishes an ionic current through the channels in the membrane, which is simultaneously recorded using an amplifier device. According to the Coulter principle, movement of particles near and specifically through the channel disrupts the current, referred to a blockade event, the signature shape of which contains information about the particle including (but not limited to) size, charge, mass, and aggregation state. Furthermore, the frequency of consecutive blockade events holds information about the concentration of the particle and diffusion characteristics. The particles are forced through the channel via applied voltage, pressure, or a combination of the same. This principle has been used widely in commercial analytical instruments such as Coulter counters, flow cytometers, and nanopore sequencers. A membrane containing more than one channel will produce a cumulative current signal through all channels. Therefore, depending on the particle properties and channel dimensions, it is difficult or impossible to accurately measure properties of an individual particle from the cumulative current signal once the number of channels on a membrane exceeds a few nanopores.

In some example embodiment according to the present invention, the disclosure relates to a method, wherein the particles are measured and counted as they travel from primary to secondary chambers via membranes with one or a few channels. The secondary chamber is equipped with a flow control system which pushes the fluid containing translocated particles through an outlet port. Using electronic control circuitry performing real-time counting, a desired number of particles can be introduced into the secondary chamber, and the particles can then be expelled and collected for further use and analysis using the flow control system. While this channel dispensing method provides single-particle accuracy, the maximum number of the particles dispensed through a few channels—limited by the particle concentration, charge, and diffusion rate—may be insufficient for certain use cases, e.g., when the required number of particles needed has to be orders of magnitude higher than what can be collected by one or a few channels.

In another example embodiment method in this invention, a membrane device with a large number of channels is used (hundreds or thousands) to dispense a large quantity of particles in a sample (herein referred to as precision mesh channel). Expected translocation rates and particle properties through a channel are initially determined by measurement on a single- or low-channel-count membrane device. The recorded translocation rates and other characteristics are used in calculating the required run duration, voltage, pressure, and other experimental parameters, which enable dispensing the desired count of particles via the channel mesh. Due to scalability of the membrane size and the number of possible channels on the membrane, the channel mesh is highly efficient in dispensing large numbers of particles. A supporting substrate can carry multiple membranes, separating multiple primary and secondary fluid chambers, and therefore one or more of the membranes of the device may be dedicated to measurement, and one or more of the membranes with channel meshes may be dedicated to efficient dispensing. Further, multiple membranes may share the same secondary chamber, allowing for controlled dispensing of different particle species from various primary chambers into a mixture in the shared secondary chamber. The initial concentration of particulates introduced into the primary chamber is also a contributing factor in the number of particles collected into the secondary chamber. At low particle concentrations, an unfavorably large amount of time would be required to collect a high number of particles into the secondary chamber since they reach the channels via diffusion. Further, at any particle concentration, the collectable fraction of particles in the primary chamber remains low, resulting in loss of starting material.

In some embodiments according to the present invention, the disclosure relates to a system for dispensing translocated particles, the system comprising: a flow cell defining multiple primary fluid chambers and at least one secondary fluid chamber, each of the multiple primary fluid chambers and the at least one secondary fluid chamber are separated at least in part by a membrane, a first portion of the membrane associated with a corresponding first primary fluid chamber and a second portion of the membrane associated with a corresponding second primary fluid chamber; and a flow-producing module in operative arrangement with the multiple primary fluid chambers and the at least one secondary fluid chamber and configured to cause a flow between the multiple primary fluid chambers and the secondary fluid chamber via the respective membrane, the flow-producing module, when activated, causes particles to translocate from the multiple primary fluid chambers to the secondary fluid chamber.

In some embodiments according to the present invention, the disclosure relates to a system for dispensing translocated particles, the system comprising: a flow cell defining multiple primary fluid chambers and at least one secondary fluid chamber, each of the multiple primary fluid chambers and the at least one secondary fluid chamber are separated at least in part by a single-channel membrane and a precision mesh membrane; and a flow-producing module in operative arrangement with the multiple primary fluid chambers and the at least one secondary fluid chamber and configured to cause a flow between the multiple primary fluid chambers and the secondary fluid chamber via a respective single-channel membrane or precision mesh membrane, the flow-producing module, when activated, causes particles to translocate from the multiple primary fluid chambers to the secondary fluid chamber. In some embodiments, a primary fluid chamber is alternatively referred to as cis channel. In some embodiments, a secondary fluid chamber is alternatively referred to as trans channel. In some embodiment, a precision mesh membrane is alternatively referred to as mesh-pore membrane (MPM). In some embodiments, a single channel membrane is alternatively referred to as single-pore membrane (SPM). In some embodiments, channels are alternatively referred to as pores. In some embodiments, the multiple primary fluid chambers include a first primary fluid chamber with the single-channel membrane, defining a single channel, through which particles exit the first primary fluid chamber a single particle at a time to the at least one secondary fluid chamber, and a second primary fluid chamber with the precision mesh membrane, defining a precision mesh arrangement of channels, through which particles exit the second primary fluid chamber multiple particles at a time to the secondary fluid chamber. In some embodiments, the translocated particles exiting the first primary fluid chamber and the translocated particles exiting the second primary fluid chamber, enter the same secondary fluid chamber(s). In some embodiments, the translocated particles exiting the first primary fluid chamber and the translocated particles exiting the second primary fluid chamber, enter different secondary fluid chamber(s). In some embodiments, the flow cell comprises an equal number of single-channel membranes and precision mesh membranes. In some embodiments, at least one primary fluid chamber defines an inlet, through which particles enter the at least one primary fluid chamber, and an outlet, through which the particles exit the at least one primary fluid chamber.

In some embodiments, the flow that causes translocation is an ionic current flow, fluid volume flow, electro-osmotic flow, or a combination thereof. In some embodiments, the flow-producing module comprises an electrode assembly configured to cause an ionic current to flow between the first portion of the membrane and the second portion of the membrane. In some embodiments, the system further comprises an adjustable power source that activates the electrode assembly to produce (i) a first strength of an electric field applied by the electrode assembly between a primary fluid chamber with a respective single-channel membrane and a corresponding at least one secondary fluid chamber and (ii) a second strength of an electric field applied by the electrode assembly between a primary fluid chamber with a respective precision mesh membrane and a corresponding at least one secondary fluid chamber, a relative magnitude of the first strength and the second strength producing predictable corresponding rates of particles to pass through a channel defined by the single-channel membrane and channels defined by the precision mesh membrane.

In some embodiments, the single-channel membrane defines a single channel with an average opening diameter of from about 10 nanometers to 10 micrometers; and the precision mesh membrane defines a precision mesh arrangement of similar circular or other geometry channels with average opening diameters of from about 10 nanometers to 10 micrometers. In some embodiments, the average opening diameter of a channel is from about 10 nanometers to 5 micrometers. In some embodiments, the average opening diameter of a channel is from about 10 nanometers to 2 micrometers. In some embodiments, the average opening diameter of a channel is from about 10 nanometers to 1 micrometers. In some embodiments, the average opening diameter of a channel is from about 100 nanometers to 1 micrometers. In some embodiments, the average opening diameter of a channel is from about 100 nanometers to 500 nanometer. In some embodiments, the average opening diameter of a channel is about 10, 20, 50, 100, 200, 300, 400, 500, 600, 700, 800, 900, 1,000, 2,000, 3,000, 4,000 or 5,000 nanometers. In some embodiments, the channels are separated by 1.1 to 100 times the diameter of each pore in the channel, and wherein the arrangement of the channels within a mesh is a regular lattice. In some embodiments, the channels are separated by 2 to 20 times the diameter of each pore in the channel, preferably by 3 to 10 times the diameter of each pore in the channel.

In some embodiments, the single-channel membrane defines a channel and the precision mesh membrane defines multiple channels, wherein the channel of the single-channel membrane and the multiple channels of the precision mesh membrane (each said channel hereinafter referred to as a “single channel”) is circular. In some embodiments, a single channel is square-shaped. In some embodiments, a single channel is rectangular. In some embodiments, a single channel is oval. In some embodiments, a single channel's shape is selected from the group consisting of: circle, square, rectangle, oval or other geometry.

In some embodiments, the single-channel membrane defines a channel configured to enable translocation of particles with average diameters ranging from at least 10% of the average diameter of the channel to 110% of the average diameter of the channel; and the precision membrane defines channels configured to enable translocation of particles with average diameters ranging from at least 10% of the average diameter of the channel to 110% of the average diameter of the channel. In some embodiments, particles are nanoparticles, microparticles or particulates. In some embodiment, particles are selected from a group consisting of proteins, nucleic acid, viruses, virus-like particles, organelles, cells and lipid nanoparticles. In some embodiments, particles are metal particles. In some embodiments, particles are synthetic particles.

In some embodiments, the single-channel membrane defines a channel and the precision mesh membrane defines multiple channels, wherein the channel of the single-channel membrane and the multiple channels of the precision mesh membrane have channel walls that are covered by a coating, wherein the coating is selected from a group consisting of: HfO₂, TiO₂, ZrO₂, Al₂O₃. SiO₂ or a combination thereof. In some embodiments, the channels are covered by a coating, wherein the coating is selected from a group consisting of: at least one layer of HfO₂, at least one layer of TiO₂, at least one layer of ZrO₂, at least one layer of Al₂O₃, at least one layer of Al₂O₃ and at least one layer of HfO₂, at least one layer of Al₂O₃ and at least one layer of SiO₂, at least one layer of Al₂O₃ and at least one layer of HfO₂, at least one layer of Al₂O₃ and at least one layer of TiO₂, at least one layer of Al₂O₃ and at least one layer of ZrO₂, or a combination thereof. In one example embodiment, the coating comprises an atomic layer of Al₂O₃, 45 layers of HfO₂, an atomic layer of Al₂O₃, and 45 atomic layers of HfO₂. In some embodiments, the coating has 1-100 nanometers thickness. In some embodiments the coating has about 10 nm thickness. In some embodiments, the coating is further covered by a layer of a compound with at least one phosphonate group. In some embodiments, the phosphonate group comprises a hydrophobic side chain (e.g., an alkyl or aryl group). In some embodiments, the phosphonate group comprises a hydrophilic side chain (e.g., polyethylene glycol (PEG)). In some embodiments, the phosphonate group comprises a polyvinyl side chain. In some embodiments, the phosphonate group comprises a bio-polymer sidechain, selected from the group including DNA, RNA, peptides, proteins, fatty acids, lipids, polysaccharides, or a combination thereof). In some embodiments, the coating is further covered by a compound comprising at least one silane group. In some embodiments, the silane group serves as a surface binding agent.

Other coating materials may also be employed, depending on the particular application. For example, various silanes include a first moiety which binds to the surface of a semiconductor membrane and a second moiety which binds to various tethered molecules. These silanes include, without limitation, 3-glycidoxypropyltrialkoxysilanes with C1-6 alkoxy groups, trialkoxy(oxiranylalkyl) silanes with C2-12 alkyl groups and C1-6 alkoxy groups, 2-(1,2-epoxycyclohexyl)ethyltrialkonsilane with C1-6 alkoxy groups, 3-butenyl trialkoxysilanes with C1-6 alkoxy groups, alkenyltrialkoxysilanes with C 2-12 alkenyl groups and C1-6 alkoxy groups, tris [(-methylethenyl)oxy]-oxiranylalkyl silanes with C2-12 alkyl groups, [5-(3,3-dimethyloxiranyl)-3-methyl-2-pentenyl]trialkoxysilane with C1-6 alkoxy groups, (2,3-oxiranediyldi-2, 1-ethartediyl)bis-triethosysilane, trialkoxy [2-(3-methyloxiranyl)alkyl]silane with C1-6 alkoxy groups and C2-12 alkyl groups, trimethoxy [2-[3-(17,17,17-triflueroheptadecyl) oxiranyl]ethyl]silane, tributoxy [3-[3-(chloromethyl) oxiranyl]-2-methylpropyl]silane, any alkylsilane where the alkyl groups have a varying length between 3 and 30 carbons, and combinations thereof. Silanes can be coupled to the semiconductor membrane according to a silanization reaction scheme (see, for example, PCT Publication Nos. WO/2006/7027580 and WO/2002/068957, the contents of which are hereby incorporated by reference in their entireties).

In some embodiment, the single-channel membranes and precision mesh membranes have an average thickness from about 1 nanometer to 50 micrometers. In some embodiment, the single-channel membranes and precision mesh membranes have an average thickness from about 1, 2, 5, 10, 20, 50, 100, 200, 500 or 1,000 nanometer. In some embodiments, the single-channel membranes and precision mesh membranes have an average thickness from about 1, 2, 3, 4, 5, 10, 12, 15, 20, 25, 30, 35, 40, 45 or 50 micrometers.

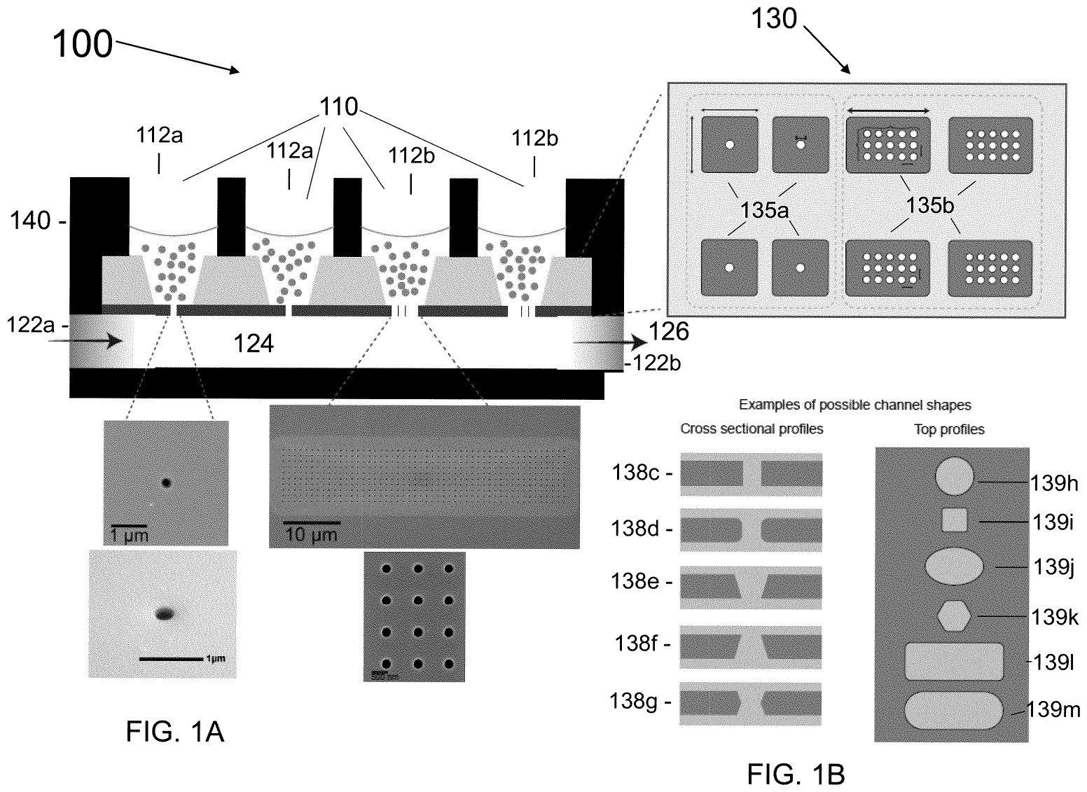

FIG. 1A is a schematic figure illustrating an example embodiment of the present invention. The example embodiment in FIG. 1A is a flow cell 100 defining primary fluid chambers 110 and a secondary fluid chamber 120. Each of primary fluid chambers 110 and the secondary fluid chamber(s) 120 are separated by a single channel membrane (135a) or a precision mesh membrane (135b), embedded on membrane 140, collectively referred to as chip 130. Primary fluid chambers associated with single-channel membranes and precision mesh membranes, define inlet(s) 112a and 112b, respectively, through which particles 116 or primary fluid 114 enter the primary fluid chambers 112a or 112b, and an outlet(s) through which the particles 116 exit the primary fluid chambers 110. The secondary fluid chamber 120 defines inlet 122a, configured to receive secondary fluid 124, and outlet 122b, configured to dispense the secondary fluid 124 and translocated particles from at least one of the multiple primary fluid chambers 110 (referred to as translocated fluid and particles 126). The example embodiments in FIG. 1B are possible channel shapes, shown as cross-sectional profiles 138c-g and top profiles 139h-m.

In one example embodiment method in this invention, the particles are measured and counted as they travel from primary to secondary chambers via membranes with one or a few channels. The secondary chamber is equipped with a flow control system which pushes the fluid containing translocated particles through an outlet port. Using electronic control circuitry performing real-time counting, a desired number of particles can be introduced into the secondary chamber, and the particles can then be expelled and collected for further use and analysis using the flow control system. While this channel dispensing method provides single-particle accuracy, the maximum number of the particles dispensed through a few channels—limited by the particle concentration, charge, and diffusion rate—may be insufficient for certain use cases, e.g., when the required number of particles needed has to be orders of magnitude higher than what can be collected by one or a few channels.

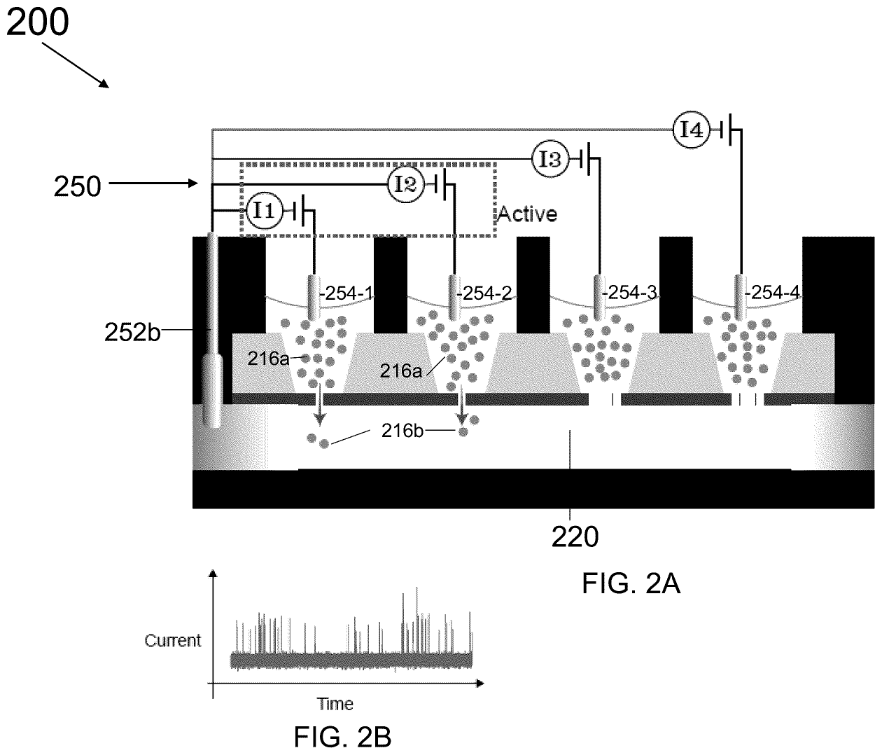

FIG. 2A is a schematic figure illustrating components of a system comprising flow cell 200 and flow producing module 250 comprising an electrode assembly. Electrodes 254-1, 254-2, 254-3 and 254-4 are placed in respective primary fluid chambers, and a reference electrode 252b is placed in secondary fluid chamber 220, configured through the electronic circuitry to cause a flow between the multiple primary fluid chambers and the secondary fluid chamber via a respective single-channel membrane or precision mesh membrane. The flow-producing module 250, when activated, causes particles 216a to translocate from the multiple primary fluid chambers to the secondary fluid chamber, through single channel membranes, herein referred to as particles 216b. The current is recorded and blockade spikes through single channel membranes are analyzed, providing measurements of particle characteristics, translocation rate, and concentration. Plot 2B is an exemplary plot recording current vs time.

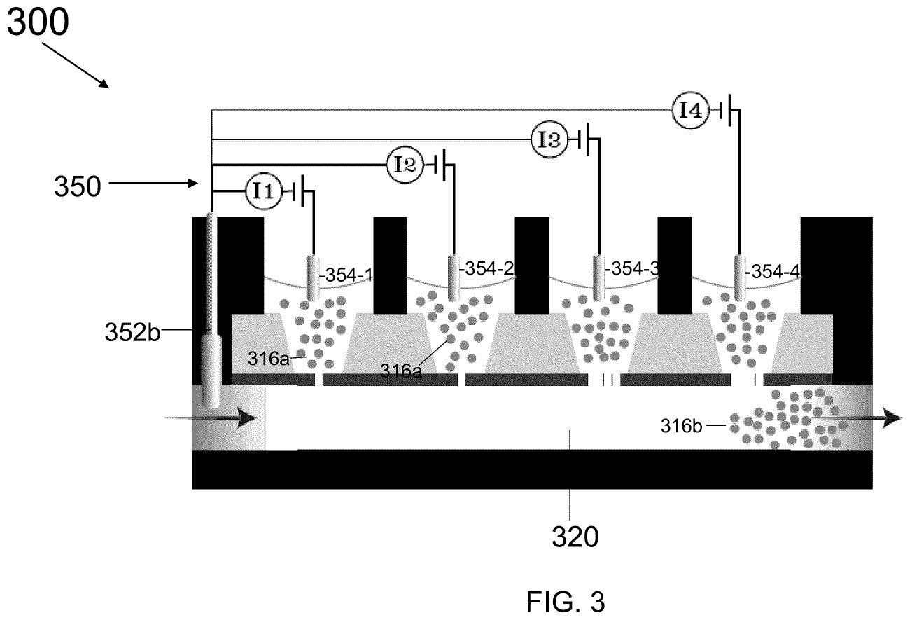

FIG. 3 is a schematic figure illustrating components of a system comprising flow cell 300 and flow producing module 350 comprising an electrode assembly. Electrodes 354-1, 354-2, 354-3 and 354-4 are placed in respective primary fluid chambers, and connected to electrode 352b placed in secondary fluid chamber 320, configured to cause a flow between the multiple primary fluid chambers and the secondary fluid chamber via a respective single-channel membrane or precision mesh membrane. The flow-producing module 350, when activated, causes particles 316a to translocate from the multiple primary fluid chambers to the secondary fluid chamber, through precision mesh membranes, herein referred to as particles 316b.

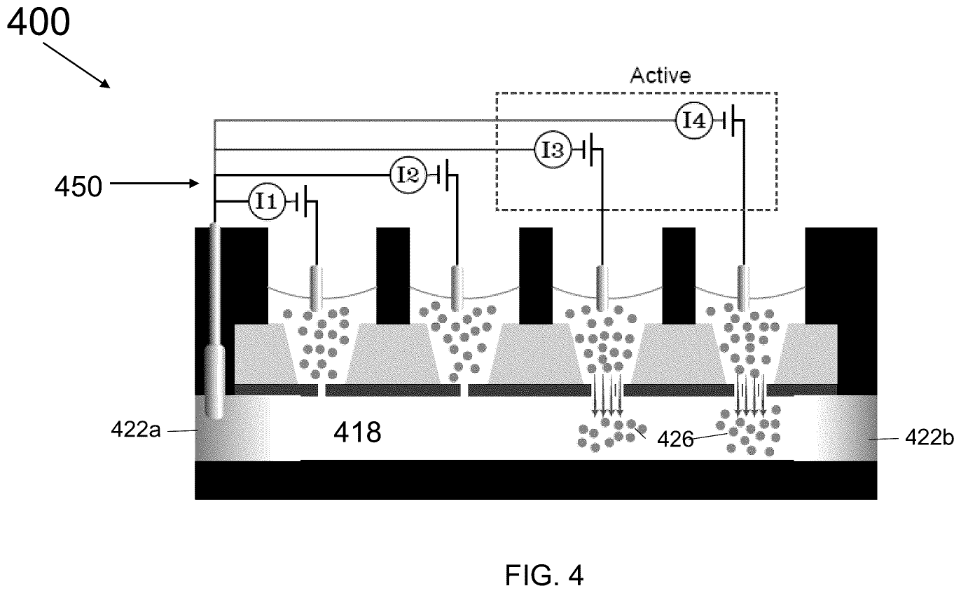

FIG. 4 is a schematic figure illustrating components of a system comprising flow cell 400 and flow producing module 450 comprising an electrode assembly. Buffer 418 is introduced through inlet 422a and to dispense translocated particles and fluid 426 through outlet 422b.

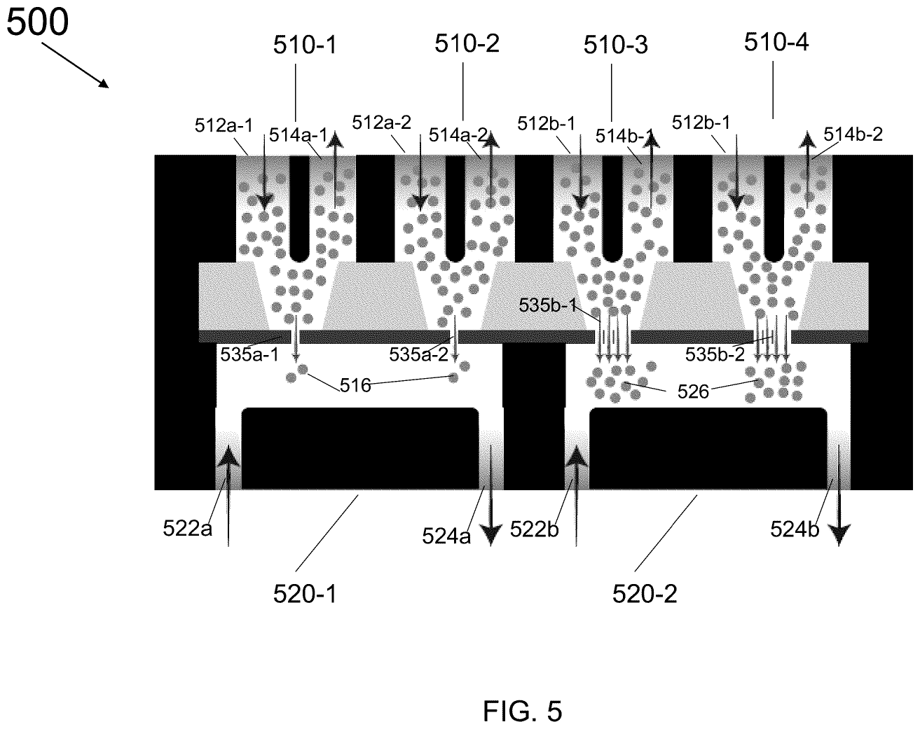

FIG. 5 is a schematic diagram illustrating a device comprising multiple primary fluid chambers and at least two secondary fluid chambers. The multiple primary fluid chambers and at least two secondary fluid chambers separated by respective portions of the membrane with single channels and precision mesh. The example embodiment in FIG. 5 is a flow cell 500 defining primary fluid chambers 510-1, 510-2, 510-3 and 510-4, and secondary fluid chambers 520-1 and 520-2. Each of the primary fluid chambers and the secondary fluid chambers are separated by a single channel membrane (535a-1 and 535a-2) or a precision mesh membrane (535b-1 and 535b-2). Primary fluid chambers associated with single-channel membranes and precision mesh membranes define inlet(s) 512a-1, 512a-2, 512b-1 and 512b-2, and outlets 514a-1, 514a-2, 514b-1 and 514b-2. Secondary fluid chambers associated with single-channel membranes and precision mesh membranes define inlet(s) 522a and 522b, through which fluid enters and translocated particles 516 and 526 collected in the fluid are pushed out of the flow cell via outlet 524a and 524b, respectively.

In some embodiments, translocated particles and fluid are dispensed into one or multiple target containers (not shown). In some embodiments, a target container is a collection tube. In some embodiments, a target container is a cell culture slide. In some embodiments, a target container is a collection plate.

In general, in some embodiments, the initial concentration of particles introduced into a primary fluid chamber may be low to a point where relying on the diffusion of the particles to reach the channel/channels would require an unfavorably large amount of time to collect a high number of particles into the secondary chamber. To overcome this limitation, a third electrode is coupled to, such as placed directly on the top surface of the membrane (applicable to single channel and precision mesh membranes). In some embodiments, a third electrode is placed directly on the top surface of a channel. The third electrode may be in contact with the fluid in the first chamber. The primary electrode suspended in the primary chamber and the third electrode, when activated, induces a voltage potential across the first chamber, electrically driving the particles toward the channels and increasing their local concentration at the channels. The driving mechanism may be electrophoresis or di-electrophoresis.

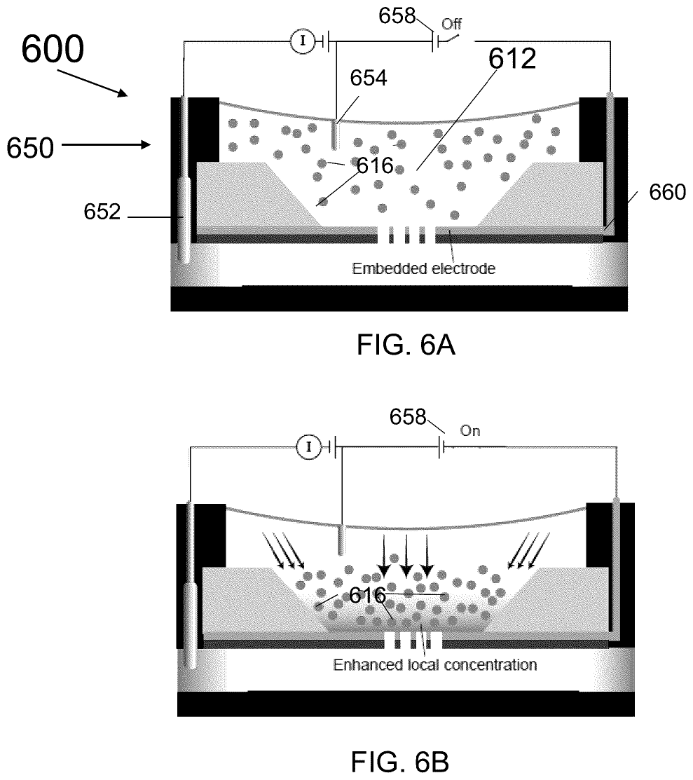

FIG. 6A and FIG. 6B are schematic figures illustrating components of a system comprising flow cell 600 and flow producing module 650 comprising an electrode assembly. Electrode 654 is placed directly on the top surface of channel 612, and electrode 652 is placed in secondary fluid chamber 620. A conductive layer 660 is coupled to the membrane and operates as an electrode to establish an electric field within channel 612. In FIG. 6A, switch 658 is open and the flow is off. In FIG. 6B, switch 658 is closed. Voltage potential induced across the chamber 612, causes particles 616 to flow toward the conductive layer.

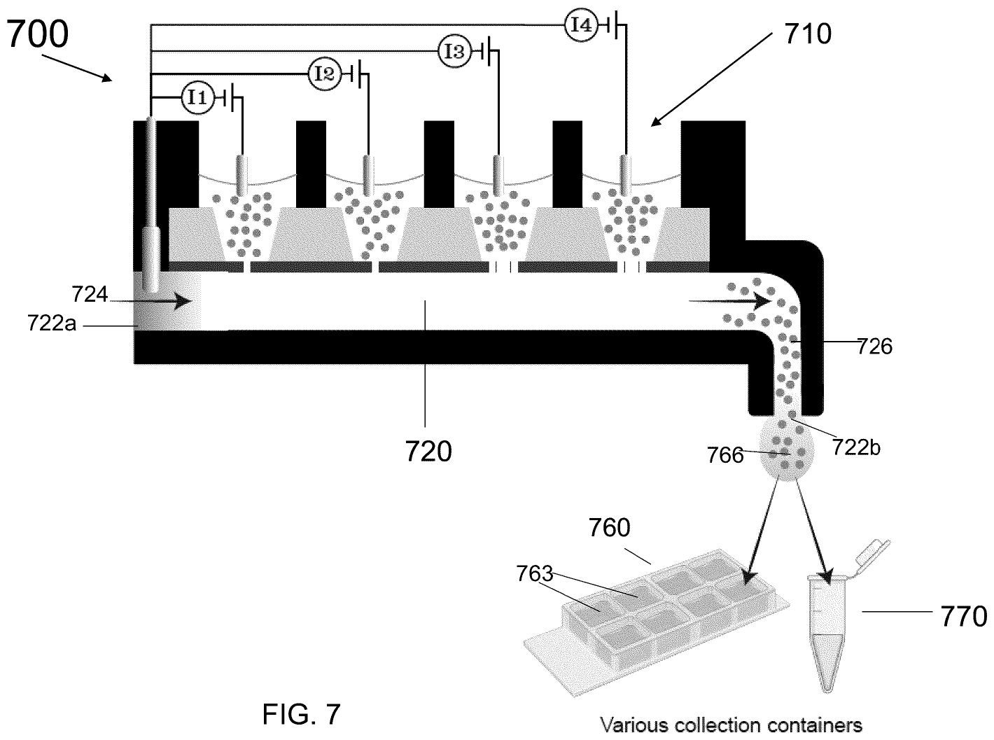

FIG. 7 is a schematic figure illustrating components of a flow cell 700 defining primary fluid chambers 710 and secondary fluid chamber 720. Controlled inflow 724 is directed to enters inlet 722a. Translocated particles and fluid 726 are dispensed through outlet 722b, in defined portions 766 (e.g., 30-60 μL), into target container 763 (e.g., chambered cell culture slide 760) or collection tube 770.

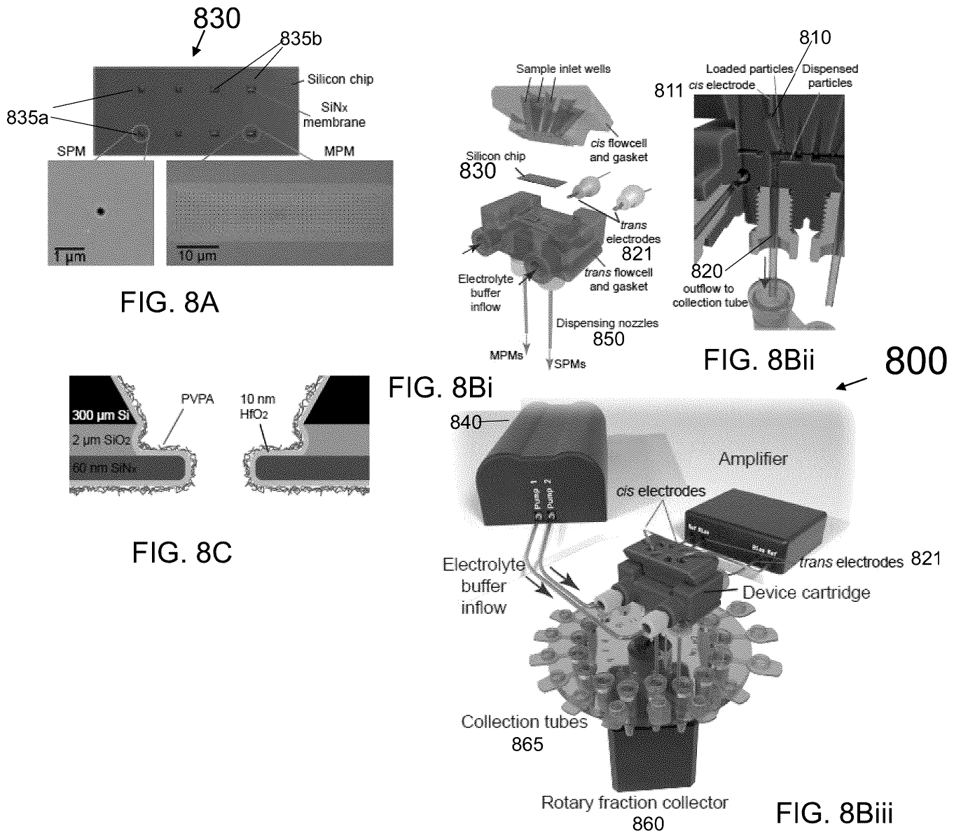

FIG. 8Bi-iii is a diagram 800 illustrating a platform for nanoparticle dispensation/collection, including a multi-window nanopore chip 830. FIG. 8A illustrates the components of nanopore chip 830. Central to the platform 800 is the 14×6×0.3 mm silicon chip 830 that comprises eight free-standing membranes with 290 nm diameter pores fabricated using e-beam lithography. One group of four membranes fabricated within 25×25 μm freestanding membranes contain single pores (referred to as single-pore membrane 835a or SPM), whereas another group of four membranes fabricated within 25×105 μm rectangular freestanding membranes contain pore meshes 835b (10×50 array) with a 1 μm pitch 837b (referred to as mesh-pore membrane 835b or MPM). The chip 830 is housed within a 3D printed flow cell and sealed using double-sided adhesive tape. Each membrane has an electrically independent cis channel (primary fluid chamber) 810 above it, where the stock nanoparticulate sample is introduced. Two trans chambers (secondary fluid channel) 820 are located below the chip, separating the SPM (single-channel membrane 835a) and MPM (precision mesh membrane 835b) groups. The electrolyte solution, phosphate-buffered saline (PBS) is flown into the trans chambers using a syringe pump 841 with programmable speed and total volume. An Ag/AgCl wire electrode 821 intersects the flow path in each trans channel using a sealed fitting. Paired with an electrode wire 811 in the cis chamber, an electric field is established across the nanopore membrane to drive particles towards the trans channel for collection. Similarly, a reversal in voltage forces particles away from the membrane and effectively shuts off translocation. A custom collection/fraction system was built to allow for the collection of electro-dispensed nanoparticle solutions. Connected to the trans channel is a syringe pump 840 that can pump fluid out of the trans chamber through low-volume tubing, which terminates in a nozzle 850 that dispenses the nanoparticles into microcentrifuge tubes 865 for collection or disposal. Fraction collection is achieved using a stepper-motor powered rotary manifold 860 that houses the microcentrifuge tubes 865. Dispensation is fully automated by executing a predefined recipe that outlines the voltage waveform and fraction collection volumes.

In some embodiments according to present invention, the disclosure relates to a method for translocating particles, wherein the method comprises enabling particles to be translocated between multiple primary fluid chambers, via a single-channel membrane and a precision mesh membrane, and at least one secondary fluid chamber; and translocating the particles from the multiple primary fluid chambers to the at least one secondary fluid chamber through activation of a flow through the single-channel membrane or the precision mesh membrane. In some embodiments, the method further comprises dispensing translocated particles into one or multiple target containers. In some embodiments, the method further comprises dispensing the translocated particles to the at least one secondary fluid chamber in a sorted order according to at least one measured property of the particles. In some embodiments, the measured property is selected from the group consisting of measuring current spike amplitude, durations, occurrence rate of current spike, or a combination thereof. In some embodiments, the method further comprises automatically loading different particle samples via the multiple primary chambers, translocating particles through a single channel membrane, one particle at a time, wherein at least one property of the translocated particles is measured, sorting the translocated particles based on the at least one measured property and routing particles with equal at least one measured property to a corresponding precision mesh membrane, and translocating said particles with equal at least one measured property through the corresponding mesh membrane. In some embodiments, the method further includes sensing a rate of translocation of single particles through the single channel of the single-channel membrane as a function of an amplitude of a flow through the single channel; and determining a number of particles translocated through the precision mesh arrangement of the precision mesh membrane as a function of the rate of translocation of the single particles through the single channel. In some embodiments, the method further comprises performing a calibration operation to correlate a quantity of particles translocating through the precision mesh arrangement with the rate of translocation of single particles through the single channel of the single-channel membrane for at least one amplitude of the flow through the single channel. In some embodiment, translocating the particles includes controlling a rate the particles are translocated.

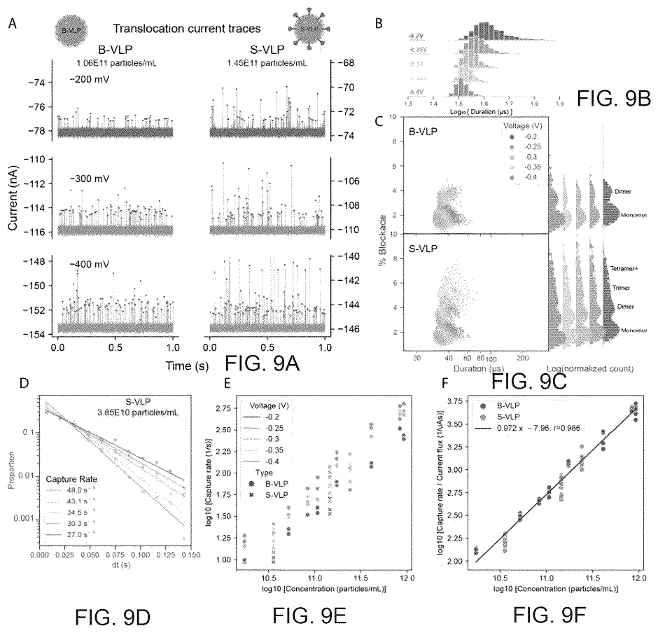

In one example embodiment, a device according to present disclosure was characterized using model virus-like particles (VLP) fabricated from 100 nm carboxylated polystyrene beads infused with a green fluorescent dye. Two particle types were produced: S-VLP particles carried a recombinant SARS-COV-2 spike protein (S1+S2) trimer and were passivated using bovine serum albumin (BSA) protein at an approximate count of 1000 and 3000 protein molecules per particle, respectively. B-VLP particles were only passivated with BSA, at 4000 protein molecules per particle. The model particles serve to show selective binding of spike protein on S-VLPs to cultured HEK-293T cells expressing ACE2 receptors, mimicking a virus/target tissue interaction. B-VLPs and ACE2-less cells (HEK-293FT) serve as negative controls with no expected binding. The solid-state nanopore chips were cleaned and chemically passivated to avoid fouling with VLPs, i.e., by sticking to the surface of silicon nitride [18]. The chemical passivation of choice here was to deposit a conformal layer of hafnium dioxide (HfO₂) using atomic-layer deposition (FIG. 8C), followed by a piranha solution cleaning step and subsequent treatment of the HfO₂-coated pores with poly-(vinylphosphonic acid) (PVPA). PVPA forms a thin and dense polyanionic network on the surface through multi-dentate interactions of phosphonate groups with the HfO₂ surface. This behavior has previously been observed between phosphonates and certain metal oxide surfaces, especially aluminum and titanium oxides. [19-21]. This coating may render the entire chip surface super-hydrophilic and highly anionic, which enhances wetting and inhibits fouling. Further, lentiviral particles pseudotyped with SARS-COV-2 spike protein were produced to demonstrate functional titering and specific activity measurement of a real viral vector carrier using our device and downstream assays. Example ionic current traces of the translocation of the three particle types through the pores at −300 m V are shown in FIG. 9A.

In one example embodiment, out of 94 tested SPM pores (23 chips), 3 showed full clogging (zero conductance), 3 had a partial blockade with a conductance of 70% lower than normal, 10 showed 80% to 150% higher than normal conductance due to erroneous assembly of the gasket tape and the flowcell, and 2 membranes were broken (conductance over 400% of normal). To further reduce the likelihood of clogging by particle aggregates, the nominal pore diameter was chosen to be 300 nm, which would allow doublets and triplets of our particles of interest (100-120 nm diameter) to pass through. The key advantage of these model particles over lentiviral vectors as a device characterization standard is their brightness under fluorescent microscopy, which allows for single particle visibility (appearing as a bright diffraction-limited spot). To quantify translocated VLPs, a microscopy-based calibration curve was developed which is capable of measuring particle concentrations as low as 3×10⁶ mL⁻¹, while only requiring a 2.5 μL droplet of sample spread on a standard microscope slide under a coverslip. The lower concentration limit of detection for other bulk fluorescence measurement devices, such as fluorescence spectrometers, plate reader, or Qubit fluorimeter were at minimum two orders of magnitude higher than the described imaging method. The slide images were taken in a 2-mm-pitch 5×5 grid with a 400 ms exposure time. The particles are algorithmically detected, and the median particle count of the 25 images is mapped onto the calibration curve to find the concentration. The calibration curve was initially developed using logarithmically spaced serial dilutions (6 points per decade) of the stock polystyrene particles with known concentrations.

### Translocation Characteristics and Dispensing of VLPs

In one embodiment, protein-coated VLPs exhibited a positive zeta potential and therefore establishing a negative voltage in the trans chamber drives them through the pore from the cis chamber. The typical current blockade signal of the translocation event through a pore (FIG. 9A) appears as a spike, from which the full-width-at-half-maximum was extracted as the event duration ta, and the event amplitude, or blockade level, was extracted as ΔI. Additionally, the inter-event time, or the time between two consecutive peaks, allowed calculation of the mean capture rates [22]. All experiments were performed under a voltage sweep from −100 mV to −400 mV at −50 mV steps. The signal-to-noise ratio at −200 mV and larger voltage magnitudes in 1×PBS is reliably high for event detection. The event duration histogram (FIG. 9B) exhibits a left shift with increasing voltage magnitude, which demonstrates that the detected events are translocations rather than collisions. This is further evidenced by trans-to-cis recapturing of translocated particles using positive voltage. The fractional blockade (ΔI/I₀) histograms of VLPs show three distinct populations (FIG. 9C) that may attribute to singular particles, doublets, and triplets. Assessing the absolute degree of aggregation of a sample requires calibration with a standard sample of known aggregation distribution, which may not be available for most use cases. However, the ability to detect these low-number aggregates provides a useful preliminary assessment of the state of the suspension.

In some embodiments, higher aggregation was observed in S-VLP compared to B-VLP samples, presumably due to stronger interactions among the his-tagged spike protein trimers and Ni/NTA functionalized particles. Fitting an exponential model Ae^{R}_{c}^{t} to histograms of inter-event time (FIG. 9D) provided the average capture rate R_{c}. In another related embodiment, a concentration sweep experiment was performed and a linear relationship was demonstrated between Re and particle concentration in cis chamber (FIG. 9E). It was shown that when Re was normalized by open pore current I₀, (FIG. 9F), the effect of pore dimension variation is lowered.

It is not feasible to collect the SPM translocated sample for use in a downstream assay; for example, given the observed capture rates for such high particle concentrations in cis—even with a hypothetical absence of clogging—it would still take 1 to 1000 hours to translocate 10⁶-10⁸ particles needed for a cell-receptor binding assay. This limitation of SPMs prompted creation of the MPMs to enable dispensing large counts in short time frames.

### Scaling the Dispensing Dynamic Range Using a Mesh of Pores

Increasing the dispensing capacity and reducing dispensing times can be achieved by using more pores in parallel. However, only the cumulative current through all the pores on a membrane could be measured, which lacks resolution to detect translocation spike signals and cannot be used to count translocated particles. To work around this limitation, SPMs and MPMs were placed on the same chips, wherein the translocation rates from the SPM recordings could be measured and the translocation rates in MPMs using the rate-to-current-flux relationship could be inferred. In one embodiment, the proximity of pores in a mesh had a dampening effect on each pore's conductance, consistent with a prior report by Hu et al. [23]. In some embodiments, an average conductance of 336 nS for SPMs and 28.5 us for 1 μm-pitch 500-pore MPMs was yielded, which amounts to ˜57 nS per pore (17% of SPM conductance). The attenuated conductance necessitates using higher voltage magnitudes for MPM dispensing and cutting off translocation (gating).

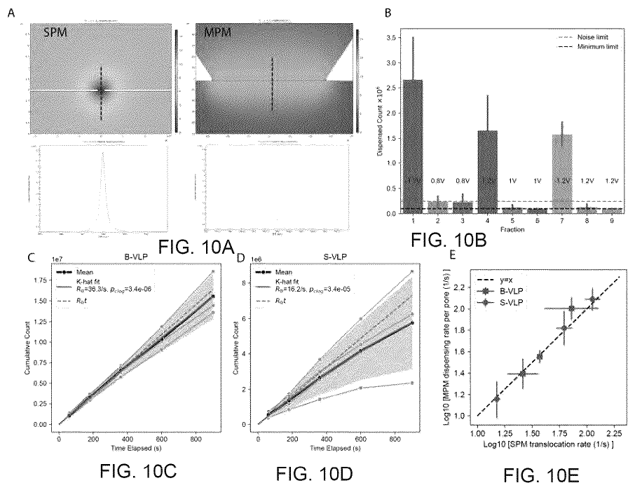

Characterizing the relationship between SPMs and MPMs requires knowing the true value of translocated particle count in the MPMs. In one embodiment, the total dispensed count of MPMs was measured by imaging the translocated particles on a slide followed by computing the concentration and count. In each MPM dispensing experiment, a predefined voltage waveform is applied and a synchronous recipe controls the timing of dispensing. In one embodiment, the positive voltage threshold for gating was demonstrated, i.e. the threshold beyond which diffusive translocation is negligible (FIG. 10B). Gating is achieved above approximately +1V, and with added safety margin, +1.5V was chosen as a reliable gating voltage. For simplicity and maintaining charge balance, −1.5V was chosen as the dispensing voltage. This voltage approximately produces −86 nA per pore, which is within a comparable range to the SPM data.

In another related embodiment, the feasibility of time controlled electro-dispensation experiments was investigated by applying a pulsed waveform with consecutive pulse widths of 1, 2, 3, 4, and 5 minutes, collecting the dispensed samples precisely at the end of each dispensing pulse. When comparing B-VLP and S-VLP sweeps (FIG. 10C-D), both trends started off linear but taper off, signaling loss in translocation rate. S-VLPs showed a more drastic loss of translocation rate, which were attributed to higher likelihood of clogging due to higher aggregation rates. In one embodiment, the loss of pores in an MPM was modeled as follows: Given a probability of clogging p_{clog} of a translocation event of a particle sample, the probability distribution of clogging for a pore at the k′th translocation event is a geometric distribution in the form of

$${Pr}_{termination} ( X = k ) = {( 1 - {p}_{clog} )}^{k - 1} {p}_{clog} .$$

k can be expressed as R₀t, where R₀ is the translocation rate of a functioning pore and t is the elapsed time. Assuming independence of clogging events across different pores, the expected proportion of open pores in an N-pore mesh (N=500) can be expressed as N (1−C D Fₜₑᵣₘᵢₙₐₜᵢₒₙ(X=R₀t))=N (1−(1−(1−p_{clog})R₀t))=N(1−p_{clog})R₀t. The expected instantaneous translocation rate of a mesh at t=τ is therefore:

$$\hat{R} ( τ , {p}_{clog} , {R}_{0} , N ) = {{NR}_{0} ( 1 - {p}_{clog} )}^{{R}_{0} τ} . \qquad ( 1 )$$

The expected count of dispensed particles through an MPM at time/can be modeled as the integral of instantaneous rate of that MPM from τ=0 when all pores are likely open to τ=1,

$$\hat{K} ( t , {p}_{clog} , {R}_{0} , N ) = {\int }_{0}^{t} {{NR}_{0} ( 1 - p )}^{{R}_{0} τ} d τ = \frac{N ( {( 1 - {p}_{clog} )}^{{R}_{0} t} - 1 )}{ln ( 1 - {p}_{clog} )} . \qquad ( 2 )$$

The \hat{ }K model was fit to the mean of the cumulative count of dispensed particles (FIG. 9C-D) using R₀ and p_{clog} as free variables. For the specific B-VLP and S-VLP samples tested, p_{clog} was found to be 10 times higher in S-VLP than B-VLP. p_{clog} of MPMs could be predicted using information available in SPM recordings, especially the aggregate ratios. For the following predictions, dispensed samples within the first 400s of the MPM's lifetime were used, approximating the cumulative dispensed count as a linear function of dispensing time. Predicting the MPM electro-dispensing rate based on the SPM translocation rate is one key enabling element of the systems in the present disclosure. As evidenced in FIG. 9F, different particle types may have different capture rates for the same concentration. To avoid the need for standardization curves for every particle type the user may want to analyze, calculations involving concentration were skipped and instead directly translated from capture rates in SPMs to dispensing rates in MPM. The steps to make this prediction are as follows: First, the average capture rate per current flux R_{sc}/Iₛ₀ is calculated for the sample analyzed via SPMs. Second, the conductance of the MPMs is measured and the average current per pore at the dispensing voltage IMP is calculated. Lastly, the predicted R_{MP}=I_{MP}R_{sc}/Iₛ₀ was obtained. When the dispensing rate per pore was plotted (via imaged dispensed samples) against the predicted R_{MP} (FIG. 10E), an almost one-to-one relationship was demonstrated. The horizontal error bars represent the standard error of prediction due to variability of R_{sc}/I₀ datapoints and vertical error bars show the standard deviation of MPM measurements obtained via imaging.

The large errors in some experiments could be due to non-uniform surface properties of the chips caused by contamination and handling errors during fabrication, cleaning, and manual assembly, and could potentially improve with streamlined cleanroom fabrication and assembly of flow cells.

### Example Features

1. the liquid containing collected translocated particles is dispensed out of the flowcell into any medium, including cell culture plates, storage vials, (e.g. Eppendorf tubes) or tubing (plastic laboratory tubing, FPLC tubing, etc.)

2. channel mesh allowing hundreds or thousands of channels to translocate particles in parallel, to meet large particle count needs.

3. Translation from single channel devices to channel meshes, where the expected particle translocation frequency of the mesh is calculated from translocation rates of single- or low-channel-count membranes.

### Example Advantages

This approach to dispensing particles in a controlled fashion allows infectivity to particle count ratios to be assessed.

It counts and provides information on particle aggregates, and it also dispenses an accurate number of particles.

### Example Uses

Accurate particle counting, concentration, size, aggregation, and charge measurement. Accurate and controlled dispensing and dosing of particles.

Applicable to biotechnology fields where viruses, virus-like particles, solid or lipid nanoparticles, vesicles, are generated and used. An embodiment of the invention may serve as a quantification and dosing tool. Example: gene therapy development and manufacturing companies.

Applicable to other industries where particles are generated and require characterization.

Accurate and scalable particle count.

Quality control of particles and viral vectors in manufactured products

While example embodiments have been particularly shown and described, it will be understood by those skilled in the art that various changes in form and details may be made therein without departing from the scope of the embodiments encompassed by the appended claims.

### Definitions

Unless defined otherwise, all technical and scientific terms used herein have the same meaning as commonly understood by one of ordinary skill in the art to which this invention is related.

The terms “a” or “an” as used herein in the specification may mean one or more. As used herein in the claim(s), when used in conjunction with the word “comprising”, the words “a” or “an” may mean one or more than one. As used herein “another” may mean at least a second or more.

The term “comprise,” or variations such as “comprises” or “comprising,” as used herein may be used to imply the inclusion of a stated element or integer or group of elements or integers, but not the exclusion of any other element or integer or group of elements or integers.

Reference throughout this specification to “one embodiment”, “an embodiment” or “some embodiments” means that a particular feature, structure or characteristic described in connection with the embodiment is included in at least one embodiment of the present invention. Thus, the appearances of the phrases “in one embodiment”, “in an embodiment” or “some embodiments” in various places throughout this specification are not necessarily all referring to the same embodiment(s). Furthermore, the particular features, structures, or characteristics may be combined in any suitable manner in one or more embodiments.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The term “alkyl” as used herein is a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dode cyl, tetradecyl, hexadecyl, eicosyl, tetracosyl, and the like. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C24 alkyl.

For example, a “C1-C3 alkyl” group can be selected from methyl, ethyl, n-propyl, i-propyl, and cyclopropyl, or from a subset thereof. In certain aspects, the “C1-C3 alkyl” group can be optionally further substituted. As a further example, a “C1-C4 alkyl” group can be selected from methyl, ethyl, n-propyl, i-propyl, cyclopropyl, n-butyl, i-butyl, s-butyl, t-butyl, and cyclobutyl, or from a subset thereof. In certain aspects, the “C1-C4 alkyl” group can be optionally further substituted. As a further example, a “C1-C6 alkyl” group can be selected from methyl, ethyl, n-propyl, i-propyl, cyclopropyl, n-butyl, i-butyl, s-butyl, t-butyl, cyclobutyl, n-pentyl, i-pentyl, s-pentyl, t-pentyl, neopentyl, cyclopentyl, n-hexyl, i-hexyl, 3-methylpentane, 2,3-dimethylbutane, neohexane, and cyclohexane, or from a subset thereof. In certain aspects, the “C1-C6 alkyl” group can be optionally further substituted. As a further example, a “C1-C8 alkyl” group can be selected from methyl, ethyl, n-propyl, i-propyl, cyclopropyl, n-butyl, i-butyl, s-butyl, t-butyl, cyclobutyl, n-pentyl, i-pentyl, s-pentyl, t-pentyl, neopentyl, cyclopentyl, n-hexyl, i-hexyl, 3-methylpentane, 2,3-dimethylbutane, neohexane, cyclohexane, heptane, cycloheptane, octane, and cyclooctane, or from a subset thereof. In certain aspects, the “C1-C8 alkyl” group can be optionally further substituted. As a further example, a “C1-C12 alkyl” group can be selected from methyl, ethyl, n-propyl, i-propyl, cyclopropyl, n-butyl, i-butyl, s-butyl, t-butyl, cyclobutyl, n-pentyl, i-pentyl, s-pentyl, t-pentyl, neopentyl, cyclopentyl, n-hexyl, i-hexyl, 3-methylpentane, 2,3-dimethylbutane, neohexane, cyclohexane, heptane, cycloheptane, octane, cyclooctane, nonane, cyclononane, decane, cyclodecane, undecane, cycloundecane, dodecane, and cyclododecane, or from a subset thereof. In certain aspects, the “C1-C12 alkyl” group can be optionally further substituted.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g. fluorine, chlorine, bromine, or iodine. The term “polyhaloalkyl” specifically refers to an alkyl group that is independently substituted with two or more halides, i.e. each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. The term “cyanoalkyl” specifically refers to an alkyl group that is substituted with one or more cyano groups. When “alkyl” is used in one instance and a specific term such as “calkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The cycloalkyl group can be substituted or unsubstituted. The cycloalkyl group can be substituted with one or more groups including, but not limited to, alkyl, cycloalkyl, alkoxy, amino, ether, halide, hydroxy, nitro, silyl, sulfo-oxo, or thiol as described herein.

The term “polyalkylene group” as used herein is a group having two or more CH₂ groups linked to one another. The polyalkylene group can be represented by the formula-(CH₂)ₐ—, where “a” is an integer of from 2 to 500.

The terms “alkoxy” and “alkoxyl” as used herein to refer to an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹—OA² or —OA¹—(OA²)ₐ—OA³, where “a” is an integer of from 1 to 200 and A¹, A², and A³ are alkyl and/or cycloalkyl groups.

The term “alkenyl” as used herein is a hydrocarbon group of from 2 to 24 carbon atoms with a structural formula containing at least one carbon-carbon double bond. Asymmetric structures such as (A¹A²)C═C (A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The cycloalkenyl group can be substituted or unsubstituted. The cycloalkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 24 carbon atoms with a structural formula containing at least one carbon-carbon triple bond. The alkynyl group can be unsubstituted or substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The cycloalkynyl group can be substituted or unsubstituted. The cycloalkynyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aromatic group” as used herein refers to a ring structure having cyclic clouds of delocalized π electrons above and below the plane of the molecule, where the π clouds contain (4n+2) π electrons. A further discussion of aromaticity is found in Morrison and Boyd, Organic Chemistry, (5th Ed., 1987), Chapter 13, entitled “Aromaticity,” pages 477-497, incorporated herein by reference. The term “aromatic group” is inclusive of both aryl and heteroaryl groups.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl refers to two aryl groups that are bound together via a fused ring structure, as in naphthalene, or are attached via one or more carbon-carbon bonds, as in biphenyl.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

As described herein, compounds of the invention may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. In is also contemplated that, in certain aspects, unless expressly indicated to the contrary, individual substituents can be further optionally substituted (i.e., further substituted or unsubstituted).

### REFERENCES

[1] Bulcha, J. T., Wang, Y., Ma, H., Tai, P. W. L. & Gao, G. Viral vector platforms within the gene therapy landscape 6, 1-24. URL https://www.nature.com/articles/s41392-021-00487-6. Number: 1 Publisher: Nature Publishing Group.
[2] Li, H. et al. Applications of genome editing technology in the targeted therapy of human diseases: mechanisms, advances and prospects 5, 1-23. URL https://www.nature.com/articles/s41392-019-0089-y. Number: 1 Publisher: Nature Publishing Group.
[3] Mingozzi, F. & High, K. A. Immune responses to AAV vectors: overcoming barriers to successful gene therapy 122, 23-36. URL https://doi.org/10.1182/blood-2013-01-306647.
[4] Valkama, A. J. et al. Development of large-scale downstream processing for lentiviral vectors 17, 717-730. URL https://www.ncbi.nlm.nih.gov/pmc/articles/PMC7177191/.
[5] Verdera, H. C., Kuranda, K. & Mingozzi, F. AAV vector immunogenicity in humans: A long journey to successful gene transfer 28, 723-746. URL https://www.ncbi.nlm.nih.gov/pmc/articles/PMC7054726/.
[6] Wagner, C., Innthaler, B., Lemmerer, M., Pletzenauer, R. & Birner-Gruenberger, R. Biophysical characterization of adeno-associated virus vectors using ionexchange chromatography coupled to light scattering detectors 23, 12715. URL https://www.mdpi.com/1422-0067/23/21/12715. Number: 21 Publisher: Multidisciplinary Digital Publishing Institute.
[7] Papanikolaou, E. et al. Characterization and comparative performance of lentiviral vector preparations concentrated by either one-step ultrafiltration or ultracentrifugation 175, 1-11. URL https://www.sciencedirect.com/science/article/pii/S0168170213001093.
[8] Heider, S. & Metzner, C. Quantitative real-time single particle analysis of virions 462-463, 199-206. URL https://www.sciencedirect.com/science/article/pii/S0042682214002669. [9] Kumru, O. S. et al. Physical characterization and stabilization of a lentiviral vector against adsorption and freeze-thaw 107, 2764-2774. URL https://www.sciencedirect.com/science/article/pii/S0022354918304131.
[10] Williams, D. B. & Carter, C. B. Transmission Electron Microscopy (Springer US). URL http://link.springer.com/10.1007/978-1-4757-2519-3.
[11] Keiser, P. T., Anantpadma, M., Staples, H., Carrion, R. & Davey, R. A. Automation of infectious focus assay for determination of filovirus titers and direct comparison to plaque and TCID50 assays 9, 156. URL https://www.mdpi.com/2076-2607/9/1/156. Number: 1 Publisher: Multidisciplinary Digital Publishing Institute.
[12] Shurtleff, A. C. et al. Standardization of the filovirus plaque assay for use in preclinical studies 4, 3511-3530. URL https://www.mdpi.com/1999-4915/4/12/3511. Number: 12 Publisher: Multidisciplinary Digital Publishing Institute.
[13] DeBlois, R. W. & Bean, C. P. Counting and sizing of submicron particles by the resistive pulse technique 41, 909-916. URL https://doi.org/10.1063/1.1684724.
[14] Akhtarian, S., Miri, S., Doostmohammadi, A., Brar, S. K. & Rezai, P. Nanopore sensors for viral particle quantification: current progress and future prospects 12, 9189-9215. URL https://doi.org/10.1080/21655979.2021.1995991. Publisher: Taylor & Francis eprint: https://doi.org/10.1080/21655979.2021.1995991.
[15] Vogel, R. et al. Quantitative sizing of nano/microparticles with a tunable elastomeric pore sensor 83, 3499-3506. URL https://doi.org/10.1021/ac200195n. Publisher: American Chemical Society.
[16] Hiemenz, C. et al. Characterization of virus particles and submicronsized particulate impurities in recombinant adeno-associated virus drug product 112, 2190-2202. URL https://www.sciencedirect.com/science/article/pii/S0022354923001971.
[17] Grabarek, A. D., Weinbuch, D., Jiskoot, W. & Hawe, A. Critical evaluation of microfluidic resistive pulse sensing for quantification and sizing of nanometer- and micrometer-sized particles in biopharmaceutical products 108, 563-573. URL https://www.sciencedirect.com/science/article/pii/S0022354918305215.
[18] Niedzwiecki, D. J., Grazul, J. & Movileanu, L. Single-molecule observation of protein adsorption onto an inorganic surface 132, 10816-10822. URL https://doi.org/10.1021/ja1026858. Publisher: American Chemical Society.
[19] Korlach, J. et al. Selective aluminum passivation for targeted immobilization of single DNA polymerase molecules in zero-mode waveguide nanostructures 105, 1176-1181. URL https://www.pnas.org/doi/full/10.1073/pnas.0710982105. Publisher: Proceedings of the National Academy of Sciences.
[20] Zeller, A. et al. Nanostructured coatings by adhesion of phosphonated polystyrene particles onto titanium surface for implant material applications 2, 2421-2428. URL https://doi.org/10.1021/am1004305. Publisher: American Chemical Society.
[21] Tosatti, S., Michel, R., Textor, M. & Spencer, N. D. Self-assembled monolayers of dodecyl and hydroxy-dodecyl phosphates on both smooth and rough titanium and titanium oxide surfaces 18, 3537-3548. URL https://doi.org/10.1021/la011459p. Publisher: American Chemical Society.
[22] Meller, A. & Branton, D. Single molecule measurements of DNA transport through a nanopore 23, 2583-2591. URL https://onlinelibrary.wiley.com/doi/abs/10.1002/1522-2683% 28200208% 2923% 3A16%3C2583%3A %3AAID-ELPS2583%3E3.0.CO %3B2-H. eprint: https://onlinelibrary.wiley.com/doi/pdf/10.1002/1522-2683% 28200208%2923%3A16%3C2583%3A %3AAIDELPS2583%3E3.0.CO %3B2-H.
[23] Hu, R. et al. Solid-state quad-nanopore array for high-resolution single-molecule analysis and discrimination 35, 2211399. URL https://onlinelibrary.wiley.com/doi/abs/10.1002/adma.202211399. eprint: https://onlinelibrary.wiley.com/doi/pdf/10.1002/adma.202211399.
[24] Booeshaghi, A. S., Beltrame, E. d. V., Bannon, D., Gehring, J. & Pachter, L. Principles of open source bioinstrumentation applied to the poseidon syringe pump system 9, 12385. URL https://www.nature.com/articles/s41598-019-48815-9. Number: 1 Publisher: Nature Publishing Group.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A system for dispensing translocated particles, the system comprising:
a flow cell defining multiple primary fluid chambers and at least one secondary fluid chamber, the multiple primary fluid chambers and the secondary fluid chamber separated at least in part by a membrane, a first portion of the membrane associated with a corresponding first primary fluid chamber and a second portion of the membrane associated with a corresponding second primary fluid chamber; and
a flow-producing module in operative arrangement with the multiple primary fluid chambers and the at least one secondary fluid chamber and configured to cause a flow between the multiple primary fluid chambers and the at least one secondary fluid chamber via a respective first portion or a respective second portion of the membrane, the flow-producing module, when activated, causes particles to translocate from the multiple primary fluid chambers to the at least one secondary fluid chamber.

2. The system of claim 1, wherein:
the first portion of the membrane is a single-channel membrane; and
the second portion of the membrane is a precision mesh membrane.

3. The system of claim 2, wherein the flow-producing module comprises an electrode assembly configured to cause an ionic current to flow between the first portion of the membrane and the second portion of the membrane.

4. The system of claim 3, wherein the electrode assembly comprises:
a conductive layer coupled to the membrane, configured to serve as an electrode; and
at least one second electrode, wherein producing a voltage potential between the conductive layer and the at least one second electrode the particles to concentrate toward the membrane.

5. The system of claim 3, further comprising an adjustable power source that activates the electrode assembly to produce (i) a first strength of an electric field applied by the electrode assembly between a primary fluid chamber with a respective single-channel membrane and a corresponding at least one secondary fluid chamber and (ii) a second strength of an electric field applied by the electrode assembly between a primary fluid chamber with a respective precision mesh membrane and a corresponding at least one secondary fluid chamber, a relative magnitude of the first strength and the second strength producing predictable corresponding rates of particles to pass through a channel defined by the single-channel membrane and channels defined by the precision mesh membrane.

6. The system of claim 2, wherein the multiple primary fluid chambers include a first primary fluid chamber with the single-channel membrane, defining a single channel through which particles exit the first primary fluid chamber a single particle at a time to the at least one secondary fluid chamber, and a second primary fluid chamber with the precision mesh membrane, defining a precision mesh arrangement of channels through which particles exit the second primary fluid chamber multiple particles at a time to at least one of the at least one secondary fluid chamber.

7. The system of claim 1, wherein at least one of the multiple primary fluid chambers defines an inlet, through which particles enter the at least one of the multiple primary fluid chambers, and an outlet, through which the particles exit the at least one of the multiple primary fluid chambers.

8. The system of claim 2, wherein the single-channel membrane defines a single circular or other geometry channel with an average opening diameter of from about 10 nanometers to 10 micrometers; and the precision mesh membrane defines a precision mesh arrangement of similar circular or other geometry channels with average opening diameters of from about 10 nanometers to 10 micrometers; and the single-channel membranes and precision mesh membranes have an average thickness from about 1 nanometer to 50 micrometers; or wherein,
the single-channel membrane defines a channel configured to enable translocation of particles with average diameters ranging from at least 10% of an average diameter of the channel to 110% of the average diameter of the channel; and
the precision membrane defines channels configured to enable translocation of particles with average diameters ranging from at least 10% of an average diameter of the channels to 110% of the average diameter of the channels.

9. (canceled)

10. The system of claim 2, wherein channels defined by the precision mesh membrane are separated by 1.1 to 100 times an average diameter of the channels, and wherein an arrangement of the channels within a mesh is a regular lattice.

11. The system of claim 2, wherein the single-channel membrane defines a channel and the precision mesh membrane defines multiple channels, wherein the channel of the single-channel membrane and the multiple channels of the precision mesh membrane have channel walls that are covered by a coating, wherein the coating is selected from a group consisting of: HfO₂, TiO₂, ZrO₂, Al₂O₃, SiO₂ or a combination thereof.

12. The system of claim 11, wherein the coating: (i) has about 1 nm to about 1 um thickness; (ii) is further covered by a layer of a compound with at least one phosphonate group, wherein the phosphonate group comprises a side chain, selected from the group consisting of an alkyl, aryl, polyethylene glycol, polyvinyl, biopolymers or a combination thereof; or (iii) is further covered by a compound with at least one silane group.

13-14. (canceled)

15. The system of claim 1, wherein the multiple primary fluid chambers include a primary fluid and wherein a given one of the at least one secondary fluid chamber defines (i) a respective inlet, configured to receive a respective secondary fluid, and (ii) a respective outlet, configured to dispense the respective secondary fluid and the particles translocated from at least one of the multiple primary fluid chambers into the given one of the at least one secondary fluid chamber.

16. The system of claim 1, wherein the flow that causes translocation is an ionic current flow, fluid volume flow, electro-osmotic flow, or a combination thereof.

17. A method for translocating particles, the method comprising:
enabling particles to be translocated between multiple primary fluid chambers, via a membrane having a first portion and a second portion, and at least one secondary fluid chamber; and
translocating the particles from the multiple primary fluid chambers to the at least one secondary fluid chamber through activation of a flow through the membrane via the first portion or the second portion.

18. The method of claim 17, further comprising dispensing translocated particles from at least one of the at least one secondary fluid chamber into one or multiple target containers, and optionally further comprising dispensing the translocated particles to the one or multiple target containers in a sorted order according to at least one measured property of the particles.

19. (canceled)

20. The method of claim 18, wherein the first portion of the membrane is a single-channel membrane that defines a single channel and the second portion of the membrane is a precision mesh membrane that defines an arrangement of channels, and further including:
sensing a rate of translocation of single particles through the single channel of the single-channel membrane as a function of an amplitude of a flow through the single channel; and
determining a number of particles translocated through the arrangement of channels through the precision mesh membrane as a function of the rate of translocation of the single particles through the single channel.

21. The method of claim 20, further comprising performing a calibration operation to correlate a quantity of particles translocating through the arrangement of channels of the precision mesh membrane with the rate of translocation of single particles through the single channel of the single-channel membrane for at least one amplitude of the flow through the single channel.

22. The method of claim 17, wherein (i) the flow that causes translocation is an ionic current flow, fluid volume flow, electro-osmotic flow, or a combination thereof; (ii) translocating the particles includes controlling a rate the particles are translocated; or (iii) generating an electric field within at least one primary fluid chamber by creating a voltage differential within the primary chamber between a conductive layer coupled to the membrane and at least one electrode, causing movement of particles towards the membrane, increasing a local concentration of the particles and translocation frequency.

23-24. (canceled)

25. A device for dispensing translocated particles, the device comprising:
multiple primary fluid chambers; and
a membrane, a first portion of the membrane associated with a corresponding first primary fluid chamber and a second portion of the membrane associated with a corresponding second primary fluid chamber, the first portion and the second portion of the membrane enabling a corresponding rate of particles to translocate therethrough.

26. The device of claim 25, wherein the first portion of the membrane is a single-channel membrane that defines a single channel through which, during operation, particles exit the first primary fluid chamber a single particle at a time, and the second portion of the membrane is a precision mesh membrane that defines a precision mesh arrangement of channels through which, during operation, particles exit the second primary fluid chamber multiple particles at a time.

27. (canceled)
